(19) United States
(12) Patent Application Publication
(10) Pub. No.: US 2010/0060568 A1
(43) Pub. Date: Mar. 11, 2010

(54) CURVED SURFACE INPUT DEVICE WITH NORMALIZED CAPACITIVE SENSING

(75) Inventors: Joseph Fisher, Cupertino, CA (US); Erturk Kocalar, Cupertino, CA (US)

Correspondence Address: APPLE c/o MOFO NOVA, 1650 TYSONS BLVD., SUITE 300, MCLEAN, VA, 22102, US

(73) Assignee: Apple Inc., Cupertino, CA (US)

(21) Appl. No.: 12/205,770

(22) Filed: Sep. 5, 2008

(51) Int. Cl. G09G 5/08; G09G 5/00

(52) U.S. Cl. 345/156

(57) ABSTRACT

A curved surface input device with normalized capacitive sensing is disclosed. The input device can normalize capacitive sensing through an overlay having a varying thickness, such as an overlay with a curved surface. The capacitive sensing normalization can be implemented in software, hardware or a combination of software and hardware. A software implementation for normalizing capacitive sensing can comprise adjusting the sensitivity of a sensing operation associated with different sensor elements of the input device. A hardware implementation for normalizing capacitive sensing can comprise adjusting a hardware configuration of the input device associated with one or more physical parameters that can influence the capacitive sensitivity of the sensor elements, such as an area of the sensor elements, a distance between the sensor elements and other conductive input device elements (such as a ground plane), and a dielectric constant associated with the overlay.

### FIELD OF THE DISCLOSURE

This relates generally to input detection, and more particularly to detecting input applied to a curved surface.

### BACKGROUND

Several varieties of input devices exist for performing operations in portable electronic devices. Some examples of input devices include buttons, switches, keyboards, mice, trackballs, touch pads, joy sticks, touch screens and the like. Some examples of portable electronic devices include media players, remote controls, personal digital assistants (PDAs), cellular phones, etc.

A user can cause an operation to be performed in a portable electronic device by applying an input to an input device. In one example, a user can move a cursor displayed on a display screen of the portable electronic device by touching an input device in a particular motion. In another example, a user can select an item displayed on the display screen by pressing an input device in a particular location.

Input devices that provide touch sensitive surfaces, such as touch panels and touch screens for example, are becoming increasingly popular because of their ease and versatility of operation. With touch sensitive surfaces, various sensor elements can be provided relative to a surface of an electronic device, and an input can be detected by sensing a change in some measure, such as capacitance for example, that is associated with the sensor elements and that exceeds a particular threshold level.

If the threshold level is set too low, the touch sensitive surface can become too sensitive, allowing unintended actions (e.g., setting the touch sensitive surface on a table) or effects (e.g., noise) to be detected as an input. If the threshold level is set too high, the touch sensitive surface can become too insensitive, allowing intended input actions (e.g., a light touching of the surface) to go undetected.

Accordingly, determining a proper threshold level for a touch sensitive device can provide unique challenges.

### SUMMARY

An input device is disclosed that can normalize capacitive sensing through an overlay having a varying thickness, such as an overlay with a curved surface for example. The capacitive sensing normalization can be implemented in software, hardware or a combination of software and hardware for example.

An overlay with a curved surface can have a varying thickness relative to the sensor elements of the input device. In a capacitive sensing input device, for example, the varying overlay thickness can alter the capacitive sensitivity of the sensor elements, causing a sensor element located beneath a thicker portion of the overlay to have a different sensitivity to an input (e.g., a touch) applied to the overlay than that of a similar sensor element located beneath a thinner portion of the overlay.

A software implementation for normalizing capacitive sensing can comprise adjusting the sensitivity of a sensing operation associated with different sensor elements of the input device for example. In this manner, the input device can compensate for the varying thickness of the overlay that can cause some of the sensor elements to be more or less sensitive to input detection than other of the sensor elements.

In one embodiment, for example, the input device can associate a particular threshold sense level with each sensor element to provide a greater range of input detection than may otherwise be possible with each sensor element being subject to the same threshold sense level. The individual sensor element threshold levels can be set manually or determined automatically in a calibration operation for example.

A hardware implementation for normalizing capacitive sensing can comprise adjusting a hardware configuration of the input device associated with one or more physical parameters that can influence the capacitive sensitivity of the sensor elements.

Such parameters can include, for example, an area of the sensor elements, a distance between the sensor elements and other conductive input device elements (such as a ground plane, for example), and a dielectric constant associated with the overlay. By arranging the areas, distances and/or dielectric constants in particular ways, the hardware configuration of the input device can normalize the capacitive sensing of the sensor elements through the overlay's varying thickness.

### BRIEF DESCRIPTION OF THE DRAWINGS

FIG. 1 illustrates an example of an electronic device.

FIG. 2 illustrates an example of an electronic device.

FIG. 3 illustrates an example of an input device.

FIGS. 4A-4D illustrate an example of different views of the input device of FIG. 3.

FIG. 5 illustrates an example of a plot of sensing operation sensitivity for a plurality of sensor elements.

FIG. 6 illustrates an example of a sensing process.

FIG. 7 illustrates an example of a sensing circuit.

FIG. 8 illustrates an example of an input device with sensor elements of varying areas.

FIG. 9 illustrates an example of an input device with a ground plane of varying density.

FIGS. 10A-10C illustrate an example of operations of an input device.

FIG. 11 illustrates an example of an input device.

FIG. 12 illustrates an example of a computing system.

FIGS. 13A-13D illustrate examples of applications of input devices.

FIGS. 14A-14B illustrate an example of an installation of an input device into a media player.

FIG. 15 illustrates an example of a remote control incorporating an input device.

### DETAILED DESCRIPTION

The present disclosure describes embodiments of an input device that can normalize capacitive sensing through an overlay having a varying thickness, such as an overlay with a curved surface for example. The capacitive sensing normalization can be implemented in software, hardware or a combination of software and hardware for example.

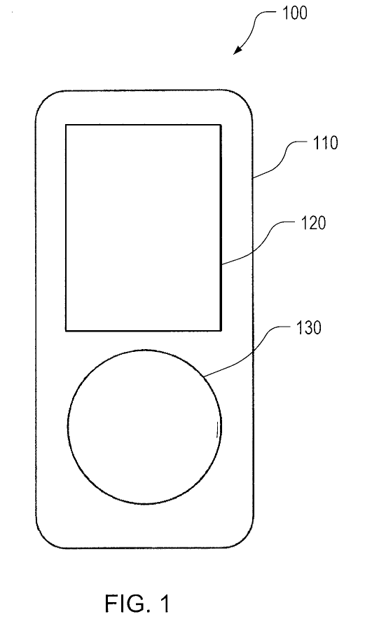

FIG. 1 illustrates an example of an electronic device. The electronic device may be any consumer electronic product. The electronic device may be a computing device and more particularly it may be a media player, PDA, phone, remote control, camera and the like. In the embodiment illustrated in FIG. 1, the electronic device 100 may correspond to a media player. The term “media player” generally refers to computing devices dedicated to processing media such as audio, video or other images, including, for example, music players, game players, video players, video recorders and the like. These devices can be portable to allow a user to, for example, listen to music, play games or video, record video or take pictures wherever the user travels. In one embodiment, the electronic device can be a handheld device that is sized for placement into a pocket of the user. By being pocket sized, the device may be taken almost anywhere the user travels (e.g., the user is not limited by carrying a large, bulky and often heavy device, as in a portable computer). Furthermore, the device can be operated in the user's hands, thus no reference surface such as a desktop is required.

Electronic devices (e.g., media players) generally have connection capabilities that allow a user to upload and download data to and from a host device, such as a general purpose computer (e.g., desktop computer, portable computer, etc.). For example, in the case of a camera, photo images can be downloaded to the general purpose computer for further processing (e.g., printing). With regard to music players, for example, songs and play lists stored on the general purpose computer can be downloaded into the music player. In the embodiment illustrated in FIG. 1, electronic device 100 can be a pocket-sized hand-held media player (e.g., MP3 player) that allows a user to store a collection of music, photos, album art, contacts, calendar entries, and other desirable media assets. It should be appreciated however, that media players are not a limitation as the electronic device may be embodied in other forms as mentioned above.

As shown in FIG. 1, electronic device 100 may include housing 110 that can enclose various electrical components, such as integrated circuit chips and other circuitry, for example. The integrated circuit chips and other circuitry may include, for example, a microprocessor, memory (e.g., ROM, RAM), a power supply (e.g., battery), a circuit board, a hard drive or Flash (e.g., Nand flash) for storing media for example, one or more orientation detection elements (e.g., accelerometer) and various input/output (I/O) support circuitry. In the case of music players, the electrical components can include components for outputting music such as an amplifier and a digital signal processor (DSP) for example. In the case of video recorders or cameras the electrical components can include components for capturing images such as image sensors (e.g., charge coupled device (CCD) or complimentary oxide semiconductor (CMOS)) or optics (e.g., lenses, splitters, filters) for example. In addition to the above, the housing can also define the shape or form of the electronic device. That is, the contour of housing 102 may embody the outward physical appearance of electronic device 100 in one embodiment.

Electronic device 100 may also include display screen 120. Display screen 120 can be used to display a graphical user interface as well as other information to the user (e.g., text, objects, graphics). By way of example, display screen 120 may be a liquid crystal display (LCD). In one embodiment, the display screen can correspond to a X-by-Y pixel high-resolution display, with a white LED backlight to give clear visibility in daylight as well as low-light conditions. Display screen 120 can also exhibit a “wide screen” aspect ratio (e.g., similar to a 16:9 aspect ratio) such that it may be relatively easy to perceive portrait and landscape orientations.

Electronic device 100 may also include input device 130. Input device 130 can be configured to provide one or more control functions for controlling various applications associated with electronic device 100. For example, a control function can be used to move an object or perform an action on display screen 120 or to make selections or issue commands associated with operating electronic device 100. Input device 130 may be widely varied. In one embodiment, input device 130 can include a rigid sensor mechanism for detecting input. The rigid sensor mechanism can include, for example, a touch sensitive surface that provides location information for an object, such as a finger for example, in contact with or in proximity to the touch sensitive surface. In another embodiment, input device 130 can include one or more movable sensor mechanisms for detecting input. The movable sensor mechanism can include, for example, one or more moving members that actuate a switch when a particular area of input device 130 is pressed. The movable sensor mechanism may operate as a mechanical push button and perform a clicking action when actuated. In a further embodiment, input device 130 may include a combination of a rigid sensor mechanism and one or more movable sensor mechanisms.

An example of an input device comprising a rigid sensor mechanism may be found in U.S. Pat. No. 7,046,230 entitled “Touch Pad Handheld Device,” which is incorporated herein by reference in its entirety. An example of an input device comprising a combination of a rigid sensor mechanism and a movable sensor mechanism may be found in U.S. patent application Ser. No. 11/812,383 entitled “Gimballed Scroll Wheel,” filed Jun. 18, 2007, which is incorporated herein by reference in its entirety.

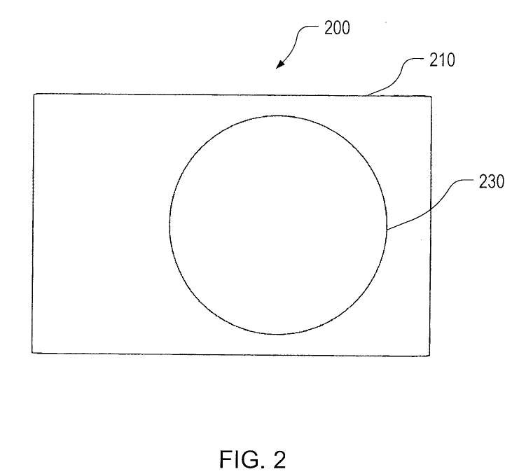

FIG. 2 illustrates an embodiment of an electronic device without a display screen. In the embodiment illustrated in FIG. 2, electronic device 200 may include housing 210 that may generally correspond to housing 110, and input device 230 that may generally correspond to input device 130. The lack of a display screen allows electronic device 200 to be configured with smaller dimensions than those of electronic device 100. For example, in one embodiment, electronic device 200 may be less than two inches wide and less than two inches tall.

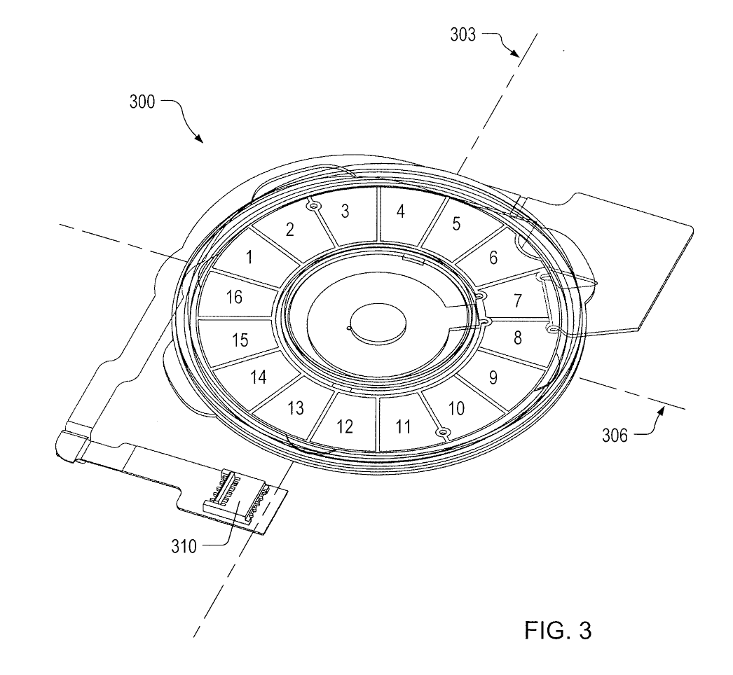

FIG. 3 illustrates an example of an input device including an arrangement of capacitive sensor elements. In the embodiment illustrated in FIG. 3, input device 300, which may generally correspond to the input devices mentioned above, can be configured to sense touch events caused by an object, such as a finger, in contact with or in proximity to a touch sensitive surface placed over capacitive sensor elements 1-16. The sensor element provided at the center of input device 300 can be configured as a movable button-type sensor element. In an alternative embodiment, the center sensor element can be configured as a capacitive sensor element or as both a capacitive sensor element and a movable button-type sensor element. Sensor elements 1-16 and the center sensor element can be controlled by controller 310.

Touch events detectable using capacitive sensor elements 1-16 of input device 300 may be widely varied, and may include, for example, rotational motion, linear motion, taps, holds, and other gestures and any combinations thereof provided by one (single touch input) or more than one (multi-touch input) of a user's fingers across the touch sensitive surface. In the embodiment illustrated in FIG. 3, the capacitive sensor elements can be configured to detect input based on the principles of self capacitance. In self capacitance, the “self” capacitance of a single electrode or sensor element is measured as for example relative to ground. In other embodiments, capacitive sensor elements can be configured to detect input based on the principles of mutual capacitance. In mutual capacitance, the mutual capacitance between a sensor element comprising at least first and second electrodes is measured. In either case, each of the sensor elements can work independently of the other sensor elements to produce simultaneously or nearly simultaneously occurring signals representative of different points of input on the touch sensitive surface at a particular time. Controller 310 can be configured to detect input using sensor elements 1-16 by measuring a change in capacitance associated with each sensor element.

An example of an input device configured to detect multiple simultaneous touches or near touches may be found in U.S. patent application Ser. No. 10/840,862 entitled “Multipoint Touchscreen,” filed May 6, 2004, which is incorporated herein by reference in its entirety. An example of a touch event model that can be associated with such an input device may be found in U.S. patent application Ser. No. 12/042,318 entitled “Touch Event Model,” filed Mar. 4, 2008, which is incorporated herein by reference in its entirety. An example of gestures that may be implemented on such an input device may be found in U.S. patent application Ser. No. 11/818,342 entitled “Gestures for Controlling, Manipulating, and Editing of Media Files Using Touch Sensitive Devices,” filed Jun. 13, 2007, which is incorporated herein by reference in its entirety.

The present disclosure is not limited to the input devices illustrated herein. Rather, an input device of any suitable technology or configuration for enabling detection of input in accordance with the teachings of the present disclosure can be utilized.

The input device can normalize capacitive sensing through an overlay having a varying thickness, such as an overlay with a curved surface for example. The capacitive sensing normalization can be implemented in software, hardware or a combination of software and hardware for example.

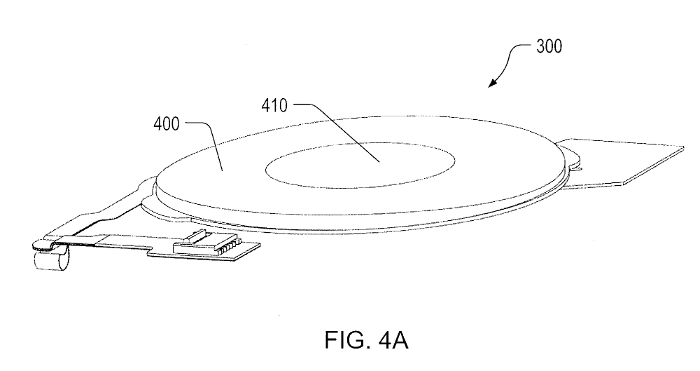

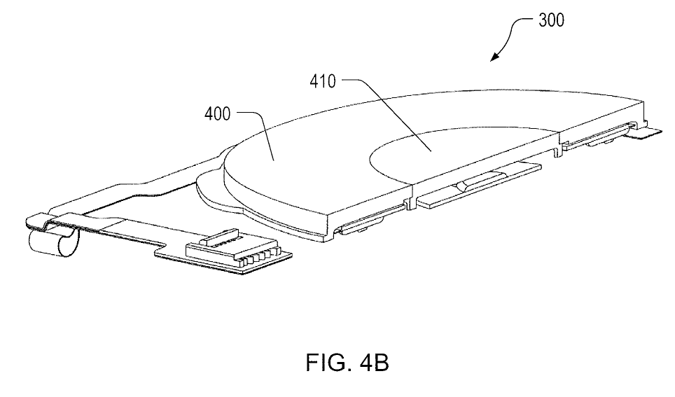

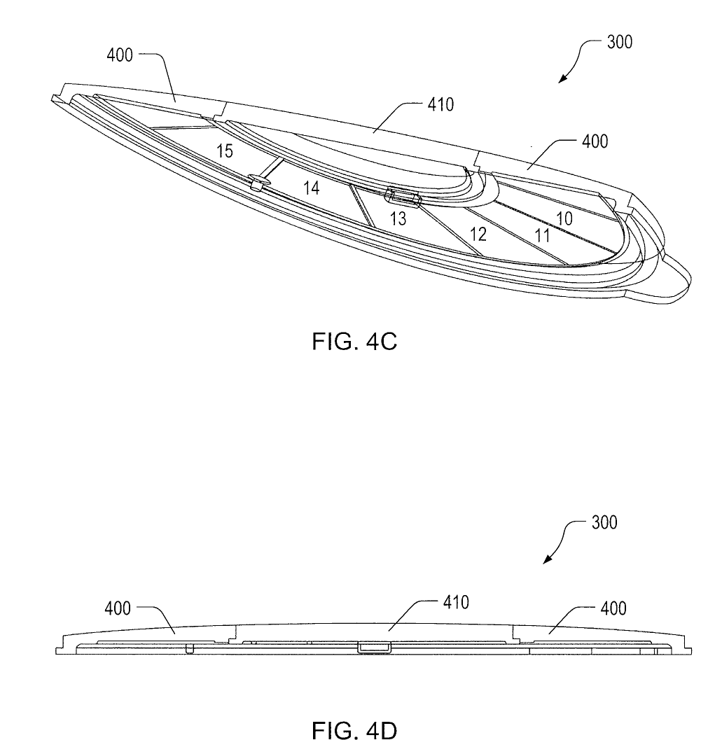

FIGS. 4A-4D illustrate an example of an overlay having a curvature that is placed over sensor elements 1-16 of input device 300. In the embodiment illustrated in FIG. 4A, input device 300 can include touch-sensitive surface, cover 400, placed over capacitive sensor elements 1-16. Cover 400 can be made of any dielectric material, such as plastic or glass for example, that can enable a capacitance to form between an object in contact with or in proximity to cover 400. Input device 300 can also include cover 410 placed over the center sensor element.

As illustrated in FIG. 4A, the thickness of cover 400 is greater along axis 303 than along axis 306. The greater and uniform thickness of cover 400 along axis 303 is illustrated in the cross-sectional view of FIG. 4B. The smaller and decreasing thickness of cover 400 along axis 306 is illustrated in the cross-sectional views of FIGS. 4C and 4D. Due to this variability in thickness and the relative uniformity of the surface area of sensor elements 1-16, and because capacitive coupling between two conducting elements (such as a sensor element and an object) is stronger when the conducting elements are closer together, a capacitive coupling formed between an object touching or approaching cover 400 over sensor elements 1, 8, 9 and 16 for example (where cover 400 is relatively thinner) can be greater than a capacitive coupling formed between the object touching or approaching cover 400 over sensor elements 4, 5, 12 and 13 for example (where cover 400 is relatively thicker).

To compensate for this difference in capacitive coupling between the object and cover 400 at various locations, input device 300 can employ a software implementation for normalizing capacitive sensing that entails associating a particular threshold sense level with each of sensor elements 1-16. A sense level generally refers to a level of a measure, such as capacitance for example, that is sensed by controller 310 in a sensing operation associated with a sensor element. A threshold sense level generally refers to the sense level that, if exceeded, results in a determination that an input has been applied to input device 300.

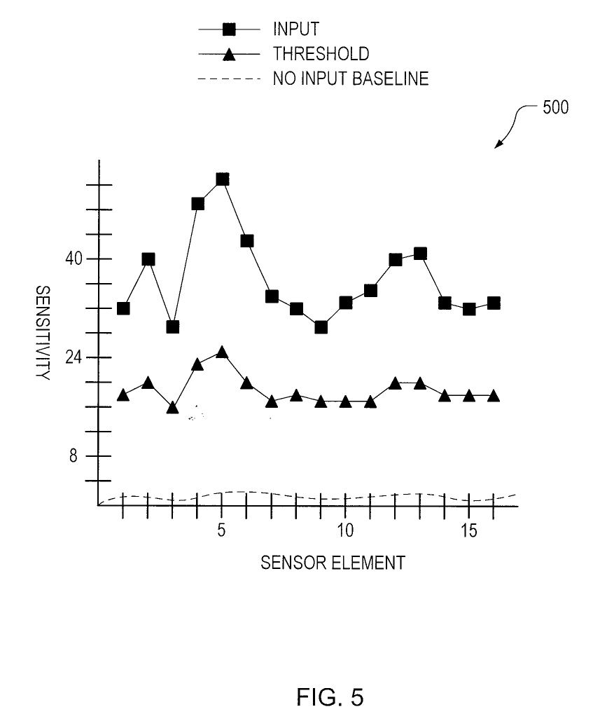

For example, FIG. 5 illustrates a plot of different sensitivity thresholds associated with each of sensor elements 1-16 of input device 300. Plot 500 graphically represents the relationship between a no input baseline sense level (depicted by the dotted line), which generally refers to a sense level without an object in contact with or in proximity to cover 400, a threshold sense level (depicted by the line with triangle plot points), and an input sense level (depicted by the line with square plot points) indicative of a sense level with an object in contact with or in proximity to cover 400. The data points provided in plot 500 are provided in TABLE 1:

TABLE 1

| Sensor | Input | Threshold |
|---|---|---|
| Element | Sense Level | Sense Level |
| 1 | 32 | 18 |
| 2 | 40 | 20 |
| 3 | 29 | 16 |
| 4 | 49 | 23 |
| 5 | 53 | 25 |
| 6 | 43 | 20 |
| 7 | 34 | 17 |
| 8 | 32 | 18 |
| 9 | 29 | 17 |
| 10 | 33 | 17 |
| 11 | 35 | 17 |
| 12 | 40 | 20 |
| 13 | 41 | 20 |
| 14 | 33 | 18 |
| 15 | 32 | 18 |
| 16 | 33 | 18 |

Plot 500 illustrates a threshold sense level established approximately midway between the no input baseline sense level and the input sense level. However, the threshold sense level can be established at any suitable level based on a desired amount of sensitivity to be accorded to sensor elements 1-16.

Due to the varied sensitivity associated with sensor elements 1-16, input device 300 can provide a greater range of input detection than may otherwise be possible with each sensor element being subject to the same threshold sense level. For example, based on the input sense level of plot 500, if input device 300 accorded only one level of sensitivity to sensor elements 1-16, then the threshold sense level may be either be too sensitive to some elements (such as sensor elements 1, 8, 9 and 16 if the threshold sense level were set only at the higher end of the illustrated threshold sense level range) or too insensitive to particular elements (such as sensor elements 4, 5, 12 and 13 if the threshold sense level were set only at the lower end of the illustrated threshold sense level range).

The individual sensor element threshold levels can be set manually or determined automatically in a calibration operation for example. In a manual threshold setting embodiment, controller 310 can measure a no input baseline sense level and an input sense level in coordination with a person not providing input and providing input, respectively, to cover 400 at the various sensor element locations, and establish an appropriate threshold sense level (e.g., such as midway between the measured sense level and no input baseline sense level). In an automatic threshold setting embodiment, controller 310 can measure only a no input baseline sense level without user input at the various sensor element locations, and establish a threshold sense level at an appropriate amount above the no input baseline sense level. The automatic threshold setting embodiment can be advantageous in situations in which an additional cover is placed over the input device (e.g., when a media player embodying the input device is placed in an armband with a clear plastic cover over the input device). In this type of situation, the no input baseline sense level calibration test can recognize more or less noise due to the placement or removal of the additional cover, and adjust the sensor element sensitivity accordingly.

In one embodiment, the threshold levels can be associated with the sensor elements in a lookup table to be accessed by controller 310 during a sensing operation. For example, a sensing operation performed by controller 310 can generate a value associated with a capacitance of the sensor element for which the sensing operation is being performed, and compare the generated value with a threshold value in the lookup table to determine whether an input is deemed to have been applied to the input device.

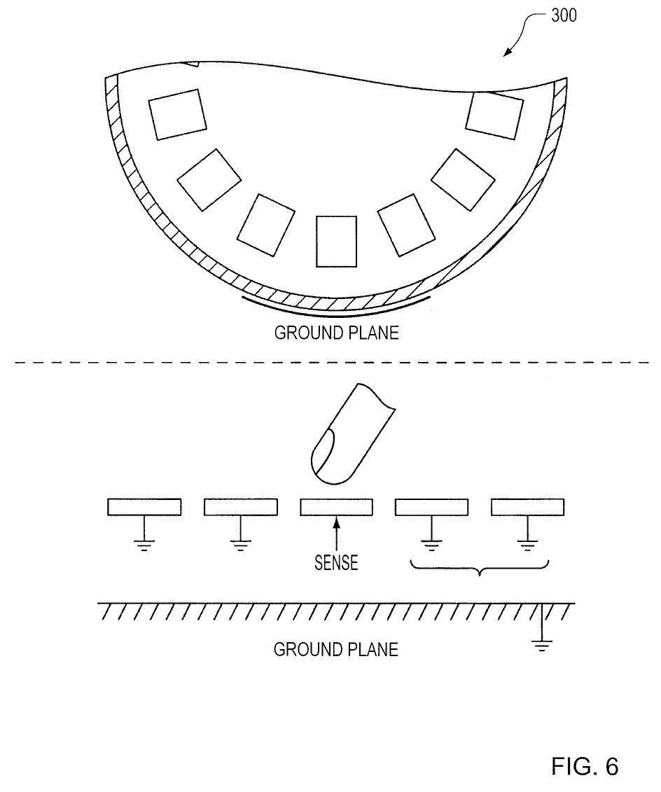

FIG. 6 illustrates an example of a sensing process in accordance with one embodiment. During a scan, controller 310 can perform a sensing operation for each of sensor elements 1-16 in consecutive fashion. When a sensing operation is being performed in association with one of the sensor elements, the other sensor elements can be grounded. In one embodiment, sensor elements can be disposed on a three-layer flexible printed circuit. The top layer can comprise conducting pad electrodes forming the sensor elements, the bottom layer can comprise a conducting surface forming a ground plane, and the middle layer can comprise traces coupling controller 310 to the sensor elements and the ground plane. Each layer can be separated by a dielectric material such as plastic for example.

An example of three-layer flexible printed circuit may be found in U.S. patent application Ser. No. 12/204,401 entitled “Compact Input Device,” filed Sep. 4, 2008, which is incorporated herein by reference in its entirety.

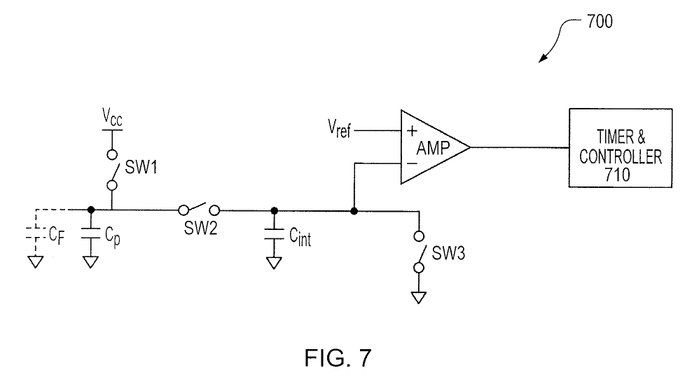

FIG. 7 illustrates an example of a sensing circuit that can implement the sensing process of FIG. 6. A parasitic capacitance Cp can represent the sum of all capacitance from a sensor element associated with a sensing operation to surrounding conductive material (e.g., sensor element to ground plane and sensor element to grounded sensor elements). The capacitance Cf associated with an object such as a finger over the sensor element can increase the total capacitance C (C=Cp+Cf) associated with the sensor element above the threshold sense level. Time and controller 710 of sensing circuit 700 via can measure a capacitance associated with a sensor element by using relatively small capacitance Cp+Cf to charge relatively large capacitance Cint (associated with an integration capacitor) to voltage threshold Vref. Sensing circuit 700 can produce a measurement value reflecting how long it takes (e.g., how may switching cycles as described below) to charge Cint to Vref. For example, a measurement value reflecting an input (e.g., the above input sense level values) can result from the time it takes for Cp+Cf to charge Cint to Vref minus the time it takes for Cp to charge Cint to Vref. Expressed formulaically, input=time(Cp+Cf)−time(Cp).

In operation, sensing circuit 700 can operate as follows:
step 0: reset and start timer (assume Cint has no charge)
step 1: open transfer switch SW2, close charge switch SW1 (these can switch alternately very fast, e.g., MHz)
   Cp+Cf are charged to Vcc (e.g., 3.0 V)
step 2: open charge switch SW1, close transfer switch SW2
   Cp+Cf charge flows to Cint
   repeat step 1 and step 2 until Cint reaches Vref (e.g., 1.1 V)
step 3: stop timer
step 4: open charge switch SW1, open transfer switch SW2, close discharge switch SW3: discharges Cint to no charge state
   open discharge switch SW3 when done
   repeat for all sensor elements

The varied sensitivity accorded to the sensor elements in this software implementation can improve the dynamic range of sensor elements in a variety of situations, and is not limited to situations in which an exterior surface covering the input device has a curvature. For example, this varied sensitivity implementation can improve the dynamic range of sensor elements that have different surface areas. A sensor element having a smaller surface area can have a different sensitivity to an input than that of a sensor element having a larger surface area because capacitive coupling between two conducting elements (such as a sensor element and an object) is stronger when the surface area of the conducting elements is greater.

This can be advantageous in situations in which there is a large difference between sensor element surface areas (e.g., the surface areas of sensor element 1-16 relative to the surface area of the center sensor element of input device 300 if configured as a capacitive sensor element) or a small difference between sensor element surface areas (e.g., the small differences in the surface areas of sensor elements 1-16 due to mechanical necessity, such as holes for locating during assembly, other notches to make room for other pieces of hardware in the unit, or manufacturing limitations such as minimum gap requirements between punched sections for example).

A hardware implementation for normalizing capacitive sensing through an overlay having a varying thickness can comprise adjusting a hardware configuration of the input device associated with one or more physical parameters that can influence the capacitive sensitivity of the sensor elements. Such parameters can include, for example, an area of the sensor elements, a distance between the sensor elements and other conductive input device elements (such as a ground plane, for example), and a dielectric constant associated with the overlay. By arranging the areas, distances and/or dielectric constants in particular ways, the hardware configuration of the input device can normalize the capacitive sensing of the sensor elements through the overlay's varying thickness.

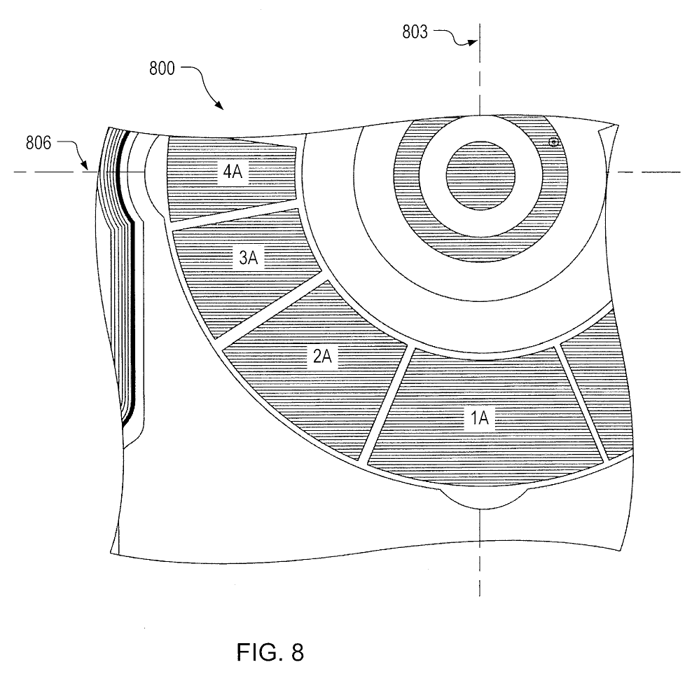

FIG. 8 illustrates an example of an input device with sensor areas having different areas. In the embodiment illustrated in FIG. 8, input device 800 may generally correspond to input device 300 described above, except that its sensor elements have different areas that are arranged to compensate for the varying thickness of cover 400. Since capacitive coupling between a sensor element and an object contacting or approaching the sensor element is directly proportional to the area of the sensor element and object, and inversely proportional to the distance between them, the sensor element areas can be formed larger in locations where cover 400 provides greater separation between the sensor element and the input surface, and smaller in locations where cover 400 provides less separation between the sensor element and the input surface.

For example, among sensor elements 1A, 2A, 3A and 4A of input device 800, sensor element 1A can have the largest area of the four sensor elements since the thickness of cover 400 is greatest along axis 803. Sensor element 4A can have the smallest area of the four sensor elements since the thickness of cover 400 is smallest along axis 806. The areas of sensor elements 2A and 3A can decrease in corresponding fashion from the area of sensor element 1A to the area of sensor element 4A to reflect the decreasing thickness of cover 400 at those sensor element locations.

The structure and/or operation of sensing circuit 700 can be optimized to accommodate sensor elements having different areas. In one embodiment, sensing circuit 700 can use a different number of integration capacitors to sense capacitance associated with different sensor elements. In another embodiment, sensing circuit 700 can change the voltage threshold Vref for different sensor elements when sensing capacitance.

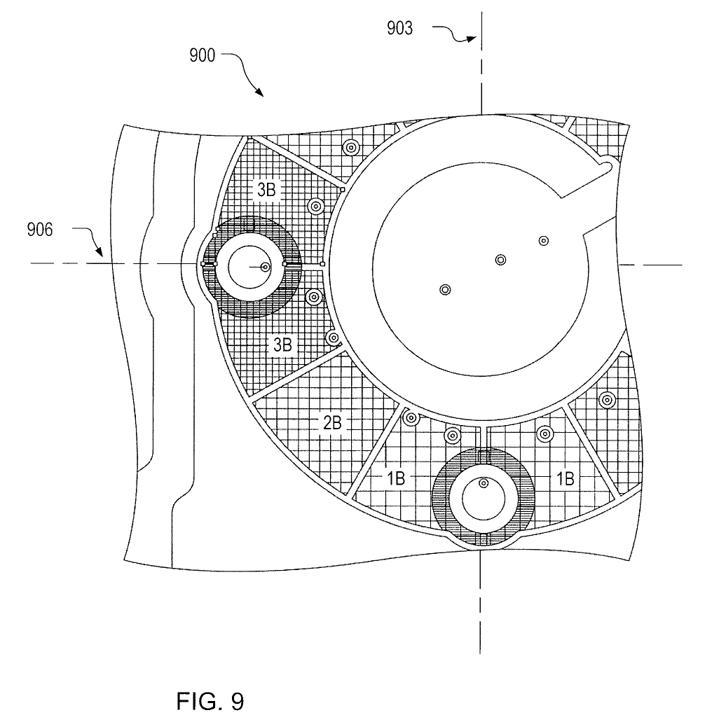

FIG. 9 illustrates an example of an input device with a ground plane comprising a varying density. In the embodiment illustrated in FIG. 9, input device 900 may generally correspond to input device 300 described above, except that its ground plane, located in a layer beneath the sensor element layer, has a varying density that is arranged to compensate for the varying thickness of cover 400. Since a parasitic capacitive coupling between a sensor element and the ground plane is directly proportional to the area of the sensor element and the ground plane, the sections of the ground plane in proximity to sensor elements in locations of greater thickness of cover 400 can be formed less densely (i.e., having less area), and sections of the ground plane in proximity to sensor elements in locations of lesser thickness of cover 400 can be formed more densely (i.e., having more area). This can enable the parasitic capacitance to be proportionally reduced or increased in areas in which the capacitance between the sensor elements and an object contacting or approaching the input surface of cover 400 is reduced or increased, respectively.

For example, among ground plane sections 1B, 2B and 3B of input device 900, ground plane section 1B can have the smallest density of the three ground plane sections since the thickness of cover 400 is greatest along axis 903. Ground plane section 3B can have the greatest density of the three ground plane sections since the thickness of cover 400 is smallest along axis 906. Ground plane section 2B can be more dense than ground plane section 1B but less dense than ground plane section 3B to reflect the decreasing thickness of cover 400 at sensor element locations corresponding to ground plane section 2B. Ground plane sections in accordance with the teachings of the present disclosure may also have no density or 100% density.

Other hardware implementations can normalize capacitive sensing through an overlay having a varying thickness in accordance with the teaching of the present disclosure. For example, in one embodiment, the distance in the z-direction (i.e., orthogonal to axes 303 and 306) between sensor elements and the ground plane can be increased or decreased at particular locations corresponding to the thickness of cover 400. This could be implemented, for example, by forming ground plane sections on different layers of the input device. In another embodiment, since capacitive coupling between a sensor element and an object contacting or approaching the sensor element is directly proportional to the dielectric constant of the material between the sensor element and object, the dielectric constant of the material forming cover 400 can be varied at particular locations corresponding to the thickness of cover 400. This could be implemented, for example, by forming cover 400 from different sections of plastic, each having a distinct dielectric constant, and combining the sections to form cover 400.

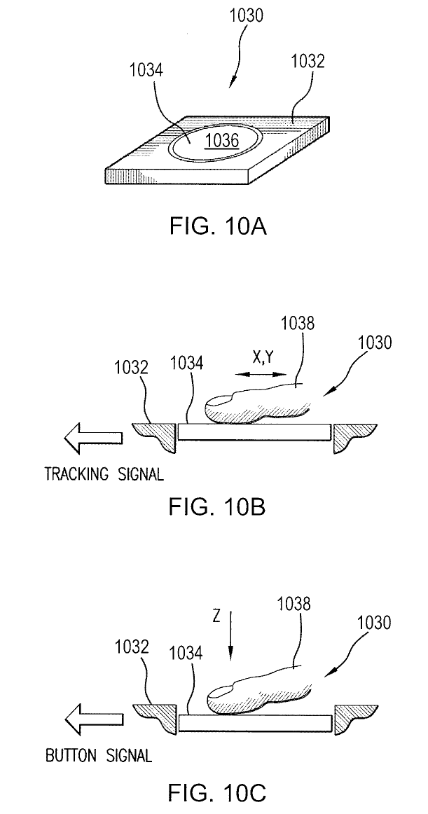

FIGS. 10A-10C illustrate operations of an input device according to some embodiments of the present disclosure. By way of example, the input device may generally correspond to any of the input devices mentioned above. In the example shown in FIG. 10A, input device 1030 can be configured to send information or data to an electronic device in order to perform an action on a display screen (e.g., via a graphical user interface). Examples of actions that may be performed include, moving an input pointer, making a selection, providing instructions, etc. The input device can interact with the electronic device through a wired connection (e.g., cable/connector) or a wireless connection (e.g., IR, Bluetooth, etc.). Input device 1030 may be a stand alone unit or it may be integrated into the electronic device. As a stand alone unit, the input device can have its own enclosure. When integrated into an electronic device, the input device can typically use the enclosure of the electronic device. In either case, the input device can be structurally coupled to the enclosure, as for example, through screws, snaps, retainers, adhesives and the like. In some cases, the input device may be removably coupled to the electronic device, as for example, through a docking station. The electronic device to which the input device may be coupled can correspond to any consumer related electronic product. By way of example, the electronic device can correspond to a computer such as a desktop computer, laptop computer or PDA, a media player such as a music player, a communication device such as a cellular phone, another input device such as a keyboard, and the like.

As shown in FIG. 10A, in this embodiment input device 1030 may include frame 1032 (or support structure) and touch pad 1034. Frame 1032 can provide a structure for supporting the components of the input device. Frame 1032 in the form of a housing can also enclose or contain the components of the input device. The components, which may include touch pad 1034, can correspond to electrical, optical and/or mechanical components for operating input device 1030. Frame 1032 may be a separate component or it may be an integral component of the housing of the electronic device.

Touch pad 1034 can provide location information for an object, such as a finger for example, in contact with or in proximity to the touch pad. This information can be used in combination with information provided by a movement indicator to generate a single command associated with the movement of the touch pad. The touch pad may be used as an input device by itself; for example, the touch pad may be used to scroll through a list of items on the device.

The shape, size and configuration of touch pad 1034 may be widely varied. In addition to the touchpad configurations disclosed above, a conventional touch pad based on the Cartesian coordinate system, or based on a Polar coordinate system can be configured to provide scrolling using rotational movements and can be configured to accept the multi-touch and gestures, for example those described herein. An example of a touch pad based on polar coordinates may be found in U.S. Pat. No. 7,046,230 which is incorporated by reference above. Furthermore, touch pad 1034 can be used in at least two different modes, which may be referred to as a relative mode and an absolute mode. In absolute mode, touch pad 1034 can, for example, report the absolute coordinates of the location at which it may be touched. For example, these would be “x” and “y” coordinates in the case of a standard Cartesian coordinate system or (r,θ) in the case of a Polar coordinate system. In relative mode, touch pad 1034 can report the direction and/or distance of change, for example, left/right, up/down, and the like. In most cases, the signals produced by touch pad 1034 can direct movement on the display screen in a direction similar to the direction of the finger as it may be moved across the surface of touch pad 1034.

Further examples of touch pad configurations may be found in U.S. patent application Ser. No. 10/949,060 entitled “Raw Data Track Pad Device and System,” filed Sep. 24, 2004, U.S. patent application Ser. No. 11/203,692 entitled “Method of Increasing the Spatial Resolution of Touch Sensitive Devices,” filed Aug. 15, 2005, and U.S. patent application Ser. No. 11/818,395 entitled “Touch Screen Stack-Ups,” filed Jun. 13, 2007, all of which are incorporated herein by reference in their entireties.

Further examples of touch pad sensing may be found in U.S. patent application Ser. No. 10/903,964 entitled “Gestures for Touch Sensitive Input Devices,” filed Jul. 30, 2004, U.S. patent application Ser. No. 11/038,590 entitled “Mode-Based Graphical User Interfaces for Touch Sensitive Input Devices,” filed Jan. 18, 2005, U.S. patent application Ser. No. 11/048,264 entitled “Gestures for Touch Sensitive Input Devices,” filed Jan. 31, 2005, U.S. patent application Ser. No. 11/232,299 entitled “System and Method for Processing Raw Data of Track Pad Device,” filed Sep. 21, 2005, and U.S. patent application Ser. No. 11/619,464 entitled “Multi-Touch Input Discrimination,” filed Jan. 3, 2007, all of which are incorporated herein by reference in their entireties.

The shape of touch pad 1034 may be widely varied. For example, it may be circular, oval, square, rectangular, triangular, and the like. In general, the outer perimeter can define the working boundary of touch pad 1034. In the embodiment illustrated in FIG. 10, the touch pad may be circular. Circular touch pads can allow a user to continuously swirl a finger in a free manner, i.e., the finger may be rotated through 360 degrees of rotation without stopping. This form of motion can produce incremental or accelerated scrolling through a list of songs being displayed on a display screen, for example. Furthermore, the user may rotate his or her finger tangentially from all sides, thus providing more finger position range. Both of these features may help when performing a scrolling function. Furthermore, the size of touch pad 1034 can accommodate manipulation by a user (e.g., the size of a finger tip or larger).

Touch pad 1034, which can generally take the form of a rigid platform. The rigid platform may be planar, convex or concave, and may include touchable outer surface 1036, which may be textured, for receiving a finger or other object for manipulation of the touch pad. Although not shown in FIG. 10A, beneath touchable outer surface 1036 can be a sensor arrangement that may be sensitive to such things as the pressure and movement of a finger thereon. The sensor arrangement may typically include a plurality of sensors that can be configured to activate as the finger sits on, taps on or passes over them. In the simplest case, an electrical signal can be produced each time the finger is positioned over a sensor. The number of signals in a given time frame may indicate location, direction, speed and acceleration of the finger on touch pad 1034, i.e., the more signals, the more the user moved his or her finger. In most cases, the signals can be monitored by an electronic interface that converts the number, combination and frequency of the signals into location, direction, speed and acceleration information. This information can then be used by the electronic device to perform the desired control function on the display screen. The sensor arrangement may be widely varied. By way of example, the sensors can be based on resistive sensing, surface acoustic wave sensing, pressure sensing (e.g., strain gauge), optical sensing, capacitive sensing and the like.

In the embodiment illustrated in FIG. 10, touch pad 1034 may be based on capacitive sensing. In most cases, the capacitive touch pad may include a protective shield, one or more electrode layers, a circuit board and associated electronics including an application specific integrated circuit (ASIC). The protective shield can be placed over the electrodes, the electrodes can be mounted on the top surface of the circuit board, and the ASIC can be mounted on the bottom surface of the circuit board. The protective shield may serve to protect the underlayers and to provide a surface for allowing a finger to slide thereon. The surface may generally be smooth so that the finger does not stick to it when moved. The protective shield also may provide an insulating layer between the finger and the electrode layers. The electrode layer may include a plurality of spatially distinct electrodes. Any suitable number of electrodes can be used. As the number of electrodes increases, the resolution of the touch pad also increases.

In accordance with one embodiment, touch pad 1034 can be movable relative to the frame 1032. This movement can be detected by a movement detector that generates another control signal. By way of example, touch pad 1034 in the form of the rigid planar platform can rotate, pivot, slide, translate, flex and/or the like relative to frame 1032. Touch pad 1034 can be coupled to frame 1032 and/or it can be movably restrained by frame 1032. By way of example, touch pad 1034 can be coupled to frame 1032 through axels, pin joints, slider joints, ball and socket joints, flexure joints, magnets, cushions and/or the like. Touch pad 1034 can also float within a space of the frame (e.g., gimbal). It should be noted that input device 1030 may additionally include a combination of joints such as a pivot/translating joint, pivot/flexure joint, pivot/ball and socket joint, translating/flexure joint, and the like to increase the range of movement (e.g., increase the degree of freedom).

When moved, touch pad 1034 can be configured to actuate a movement detector circuit that generates one or more signals. The circuit may generally include one or more movement detectors such as switches, sensors, encoders, and the like.

In the embodiment illustrated in FIG. 10, touch pad 1034 can be part of a depressible platform. The touch pad can operate as a button and perform one or more mechanical clicking actions. Multiple functions or the same function of the device may be accessed by depressing the touch pad 1034 in different locations. A movement detector signals that touch pad 1034 has been depressed, and touch pad 1034 signals a location on the platform that has been touched. By combining both the movement detector signals and touch pad signals, touch pad 1034 acts like multiple buttons such that depressing the touch pad at different locations corresponds to different buttons. As shown in FIGS. 10B and 10C, according to one embodiment touch pad 1034 can be capable of moving between an upright position (FIG. 10B) and a depressed position (FIG. 10C) when a requisite amount of force from finger 1038, palm, hand or other object is applied to touch pad 1034. Touch pad 1034 can be spring biased in the upright position, as for example through a spring member. Touch pad 1034 moves to the depressed position when the spring bias is overcome by an object pressing on touch pad 1034.

As shown in FIG. 10B, touch pad 1034 generates tracking signals when an object such as a user's finger is moved over the top surface of the touch pad in the x, y plane. As shown in FIG. 10C, in the depressed position (z direction), touch pad 1034 generates positional information and a movement indicator generates a signal indicating that touch pad 1034 has moved. The positional information and the movement indication can be combined to form a button command. Different button commands or the same button command can correspond to depressing touch pad 1034 in different locations. The button commands may be used for various functionalities including, but not limited to, making selections or issuing commands associated with operating an electronic device. By way of example, in the case of a music player, the button commands may be associated with opening a menu, playing a song, fast forwarding a song, seeking through a menu and the like.

To elaborate, touch pad 1034 can be configured to actuate a movement detector, which together with the touch pad positional information, can form a button command when touch pad 1034 is moved to the depressed position. The movement detector can be located within frame 1032 and coupled to touch pad 1034 and/or frame 1032. The movement detector may be any combination of switches and sensors. Switches can be generally configured to provide pulsed or binary data such as activate (on) or deactivate (off). By way of example, an underside portion of touch pad 1034 can be configured to contact or engage (and thus activate) a switch when the user presses on touch pad 1034. The sensors, on the other hand, can be generally configured to provide continuous or analog data. By way of example, the sensor can be configured to measure the position or the amount of tilt of touch pad 1034 relative to the frame when a user presses on the touch pad 1034. Any suitable mechanical, electrical and/or optical switch or sensor may be used. For example, tact switches, force sensitive resistors, pressure sensors, proximity sensors, and the like may be used. In some case, the spring bias for placing touch pad 1034 in the upright position may be provided by a movement detector that includes a spring action. In other embodiments, input device 1030 can include one or more movement detectors in various locations positioned under and/or above touch pad 1034 to form button commands associated with the particular locations in which the movement detector is actuated.

Touch pad 1034 may can also be configured to provide a force feedback response. An example of touch pad configuration providing a haptic feedback response may be found in U.S. Pat. No. 6,337,678 entitled “Force Feedback Computer Input and Output Device with Coordinated Haptic Elements,” which is incorporated herein by reference in its entirety.

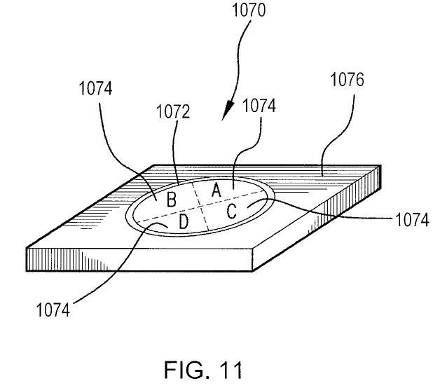

FIG. 11 illustrates a simplified perspective diagram of input device 1070. Like the input device shown in the embodiment of FIGS. 10A-10C, this input device 1070 incorporates the functionality of one or more buttons directly into touch pad 1072, i.e., the touch pad acts like a button. In this embodiment, however, touch pad 1072 can be divided into a plurality of independent and spatially distinct button zones 1074. Button zones 1074 may represent regions of the touch pad 1072 that can be moved by a user to implement distinct button functions or the same button function. The dotted lines may represent areas of touch pad 1072 that make up an individual button zone. Any number of button zones may be used, for example, two or more, four, eight, etc. In the embodiment illustrated in FIG. 11, touch pad 1072 may include four button zones 1074 (i.e., zones A-D).

As should be appreciated, the button functions generated by pressing on each button zone may include selecting an item on the screen, opening a file or document, executing instructions, starting a program, viewing a menu, and/or the like. The button functions may also include functions that make it easier to navigate through the electronic system, as for example, zoom, scroll, open different menus, home the input pointer, perform keyboard related actions such as enter, delete, insert, page up/down, and the like. In the case of a music player, one of the button zones may be used to access a menu on the display screen, a second button zone may be used to seek forward through a list of songs or fast forward through a currently playing song, a third button zone may be used to seek backwards through a list of songs or fast rearward through a currently playing song, and a fourth button zone may be used to pause or stop a song that may be in the process of being played.

To elaborate, touch pad 1072 can be capable of moving relative to frame 1076 so as to create a clicking action. Frame 1076 can be formed from a single component or a combination of assembled components. The clicking action can actuate a movement detector contained inside frame 1076. The movement detector can be configured to sense movements of the button zones during the clicking action and to send a signal corresponding to the movement to the electronic device. By way of example, the movement detectors may be switches, sensors and/or the like.

In addition, touch pad 1072 can be configured to send positional information on what button zone may be acted on when the clicking action occurs. The positional information can allow the device to determine which button zone to activate when the touch pad is moved relative to the frame.

The movements of each of button zones 1074 may be provided by various rotations, pivots, translations, flexes and the like. In one embodiment, touch pad 1072 can be configured to gimbal relative to frame 1076. By gimbal, it is generally meant that the touch pad 1072 can float in space relative to frame 1076 while still being constrained thereto. The gimbal can allow the touch pad 1072 to move in single or multiple degrees of freedom (DOF) relative to the housing, for example, movements in the x, y and/or z directions and/or rotations about the x, y, and/or z axes (θxθyθz).

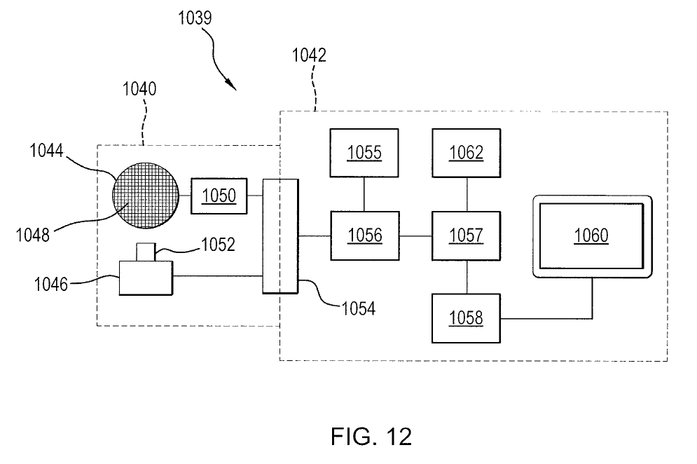

FIG. 12 illustrates an example of a simplified block diagram of a computing system 1039. The computing system may generally include input device 1040 operatively connected to computing device 1042. By way of example, input device 1040 can generally correspond to input device 1030 shown in FIGS. 10A-10C, and the computing device 1042 can correspond to a computer, PDA, media player or the like. As shown, input device 1040 may include depressible touch pad 1044 and one or more movement detectors 1046. Touch pad 1044 can be configured to generate tracking signals and movement detector 1046 can be configured to generate a movement signal when the touch pad is depressed. Although touch pad 1044 may be widely varied, in this embodiment, touch pad 1044 can include capacitance sensors 1048 and control system 1050 (which can generally correspond to the controller 310 described above) for acquiring position signals from sensors 1048 and supplying the signals to computing device 1042. Control system 1050 can include an application specific integrated circuit (ASIC) that can be configured to monitor the signals from sensors 1048, to compute the absolute location, angular location, direction, speed and/or acceleration of the monitored signals and to report this information to a processor of computing device 1042. Movement detector 1046 may also be widely varied. In this embodiment, however, movement detector 1046 can take the form of a switch that generates a movement signal when touch pad 1044 is depressed. Movement detector 1046 can correspond to a mechanical, electrical or optical style switch. In one particular implementation, movement detector 1046 can be a mechanical style switch that includes protruding actuator 1052 that may be pushed by touch pad 1044 to generate the movement signal. By way of example, the switch may be a tact or dome switch.

Both touch pad 1044 and movement detector 1046 can be operatively coupled to computing device 1042 through communication interface 1054. The communication interface provides a connection point for direct or indirect connection between the input device and the electronic device. Communication interface 1054 may be wired (wires, cables, connectors) or wireless (e.g., transmitter/receiver).

Referring to computing device 1042, it may include processor 1057 (e.g., CPU or microprocessor) configured to execute instructions and to carry out operations associated with computing device 1042. For example, using instructions retrieved from memory, the processor can control the reception and manipulation of input and output data between components of computing device 1042. Processor 1057 can be configured to receive input from both movement detector 1046 and touch pad 1044 and can form a signal/command that may be dependent upon both of these inputs. In most cases, processor 1057 can execute instruction under the control of an operating system or other software. Processor 1057 may be a single-chip processor or may be implemented with multiple components.

Computing device 1042 may also include input/output (I/O) controller 1056 that can be operatively coupled to processor 1057. (I/O) controller 1056 can be integrated with processor 1057 or it may be a separate component as shown. I/O controller 1056 can generally be configured to control interactions with one or more I/O devices that may be coupled to the computing device 1042, as for example input device 1040 and orientation detector 1055, such as an acclerometer. I/O controller 1056 can generally operate by exchanging data between computing device 1042 and I/O devices that desire to communicate with computing device 1042.

Computing device 1042 may also include display controller 1058 that can be operatively coupled to processor 1057. Display controller 1058 can be integrated with processor 1057 or it may be a separate component as shown. Display controller 1058 can be configured to process display commands to produce text and graphics on display screen 1060. By way of example, display screen 1060 may be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays and the like. In the embodiment illustrated in FIG. 12, the display device corresponds to a liquid crystal display (LCD).

In some cases, processor 1057 together with an operating system operates to execute computer code and produce and use data. The computer code and data can reside within program storage area 1062 that may be operatively coupled to processor 1057. Program storage area 1062 can generally provide a place to hold data that may be used by computing device 1042. By way of example, the program storage area may include Read-Only Memory (ROM), Random-Access Memory (RAM), hard disk drive and/or the like. The computer code and data could also reside on a removable program medium and loaded or installed onto the computing device when needed. In one embodiment, program storage area 1062 can be configured to store information for controlling how the tracking and movement signals generated by the input device may be used, either alone or in combination for example, by computing device 1042 to generate an input event command, such as a single button press for example.

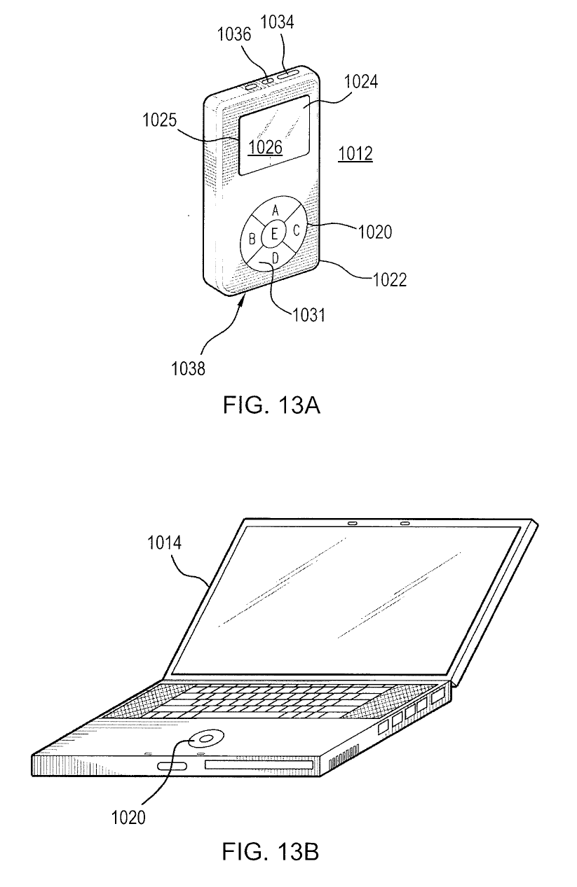

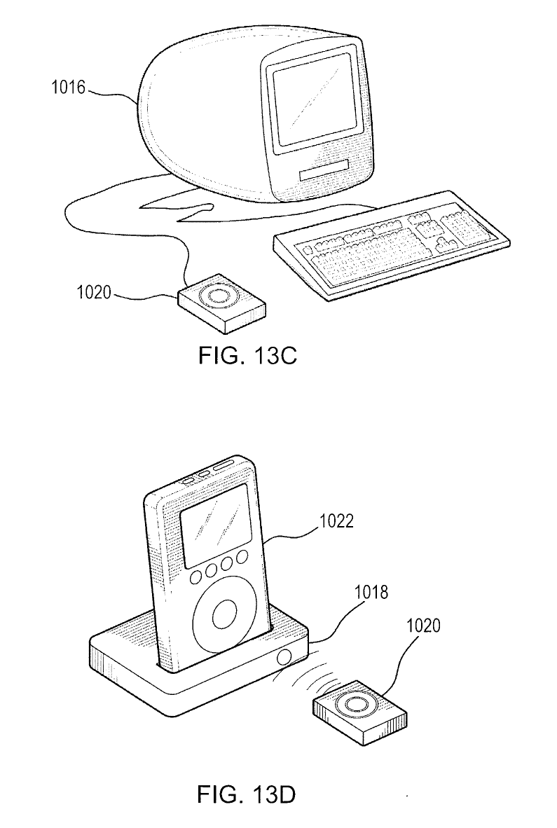

FIGS. 13A-13D illustrate applications of an input device according to some embodiments of the present disclosure. As previously mentioned, the input devices described herein can be integrated into an electronic device or they can be separate stand alone devices. FIGS. 13A-13D show some implementations of input device 1020 integrated into an electronic device. FIG. 13A shows input device 1020 incorporated into media player 1012. FIG. 13B shows input device 1020 incorporated into laptop computer 1014. FIGS. 13C and 13D, on the other hand, show some implementations of input device 1020 as a stand alone unit. FIG. 13C shows input device 1020 as a peripheral device that can be connected to desktop computer 1016. FIG. 13D shows input device 1020 as a remote control that wirelessly connects to docking station 1018 with media player 1022 docked therein. It should be noted, however, that in some embodiments the remote control can also be configured to interact with the media player (or other electronic device) directly, thereby eliminating the need for a docking station. An example of a docking station for a media player may be found in U.S. patent application Ser. No. 10/423,490, entitled “Media Player System,” filed Apr. 25, 2003, which is incorporated herein by reference in its entirety. It should be noted that these particular embodiments do not limit the present disclosure and that many other devices and configurations may be used.

Referring back to FIG. 13A, media player 1012, housing 1022 and display screen 1024 may generally correspond to those described above. As illustrated in the embodiment of FIG. 13A, display screen 1024 can be visible to a user of media player 1012 through opening 1025 in housing 1022 and through transparent wall 1026 disposed in front of opening 1025. Although transparent, transparent wall 1026 can be considered part of housing 1022 since it helps to define the shape or form of media player 1012.

Media player 1012 may also include touch pad 1020 such as any of those previously described. Touch pad 1020 can generally consist of touchable outer surface 1031 for receiving a finger for manipulation on touch pad 1020. Although not illustrated in the embodiment of FIG. 13A, beneath touchable outer surface 1031 a sensor arrangement can be configured in a manner as previously described. Information provided by the sensor arrangement can be used by media player 1012 to perform the desired control function on display screen 1024. For example, a user may easily scroll through a list of songs by swirling the finger around touch pad 1020.

In addition to above, the touch pad may also include one or more movable buttons zones A-D as well as a center button E for example. The button zones can be configured to provide one or more dedicated control functions for making selections or issuing commands associated with operating media player 1012. By way of example, in the case of an MP3 music player, the button functions can be associated with opening a menu, playing a song, fast forwarding a song, seeking through a menu, making selections and the like. In some embodiments, the button functions can be implemented via a mechanical clicking action.

The position of touch pad 1020 relative to housing 1022 may be widely varied. For example, touch pad 1020 can be placed at any external surface (e.g., top, side, front, or back) of housing 1022 accessible to a user during manipulation of media player 1012. In some embodiments, touch sensitive surface 1031 of touch pad 1020 can be completely exposed to the user. In the embodiment illustrated in FIG. 13A, touch pad 1020 can be located in a lower front area of housing 1022. Furthermore, touch pad 1020 can be recessed below, level with, or extend above the surface of housing 1022. In the embodiment illustrated in FIG. 13A, touch sensitive surface 1031 of touch pad 1020 can be substantially flush with the external surface of housing 1022.

The shape of touch pad 1020 may also be widely varied. Although illustrated as circular in the embodiment of FIG. 13A, the touch pad can also be square, rectangular, triangular, and the like for example. More particularly, the touch pad can be annular, i.e., shaped like or forming a ring. As such, the inner and outer perimeter of the touch pad can define the working boundary of the touch pad.

Media player 1012 may also include hold switch 1034. Hold switch 1034 can be configured to activate or deactivate the touch pad and/or buttons associated therewith for example. This can be generally done to prevent unwanted commands by the touch pad and/or buttons, as for example, when the media player is stored inside a user's pocket. When deactivated, signals from the buttons and/or touch pad cannot be sent or can be disregarded by the media player. When activated, signals from the buttons and/or touch pad can be sent and therefore received and processed by the media player.

Moreover, media player 1012 may also include one or more headphone jacks 1036 and one or more data ports 1038. Headphone jack 1036 can be capable of receiving a headphone connector associated with headphones configured for listening to sound being outputted by media player 1012. Data port 1038, on the other hand, can be capable of receiving a data connector/cable assembly configured for transmitting and receiving data to and from a host device such as a general purpose computer (e.g., desktop computer, portable computer). By way of example, data port 1038 can be used to upload or download audio, video and other images to and from media player 1012. For example, the data port can be used to download songs and play lists, audio books, ebooks, photos, and the like into the storage mechanism of the media player.

Data port 1038 may be widely varied. For example, the data port can be a PS/2 port, a serial port, a parallel port, a USB port, a Firewire port and/or the like. In some embodiments, data port 1038 can be a radio frequency (RF) link or optical infrared (IR) link to eliminate the need for a cable. Although not illustrated in the embodiment of FIG. 13A, media player 1012 can also include a power port that receives a power connector/cable assembly configured for delivering power to media player 1012. In some cases, data port 1038 can serve as both a data and power port. In the embodiment illustrated in FIG. 13A, data port 1038 can be a USB port having both data and power capabilities.

Although only one data port may be shown, it should be noted that this does not limit the present disclosure and that multiple data ports may be incorporated into the media player. In a similar vein, the data port can include multiple data functionality, i.e., integrating the functionality of multiple data ports into a single data port. Furthermore, it should be noted that the position of the hold switch, headphone jack and data port on the housing may be widely varied, in that they are not limited to the positions shown in FIG. 13A. They can be positioned almost anywhere on the housing (e.g., front, back, sides, top, bottom). For example, the data port can be positioned on the top surface of the housing rather than the bottom surface as shown.

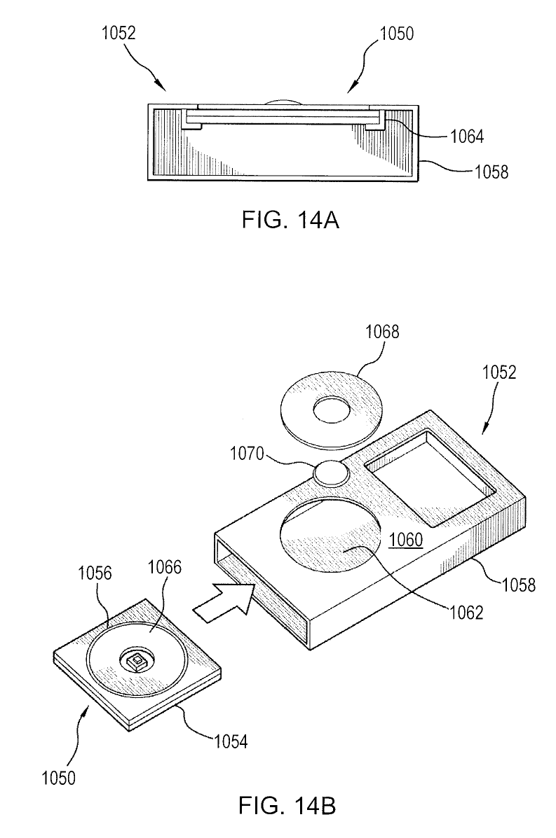

FIGS. 14A and 14B illustrate installation of an input device into a media player according to some embodiments of the present disclosure. By way of example, input device 1050 may correspond to any of those previously described and media player 1052 may correspond to the one shown in FIG. 13A. As shown, input device 1050 may include housing 1054 and touch pad assembly 1056. Media player 1052 may include shell or enclosure 1058. Front wall 1060 of shell 1058 may include opening 1062 for allowing access to touch pad assembly 1056 when input device 1050 is introduced into media player 1052. The inner side of front wall 1060 may include channel or track 1064 for receiving input device 1050 inside shell 1058 of media player 1052. Channel 1064 can be configured to receive the edges of housing 1054 of input device 1050 so that input device 1050 can be slid into its desired place within shell 1058. The shape of the channel can have a shape that generally coincides with the shape of housing 1054. During assembly, circuit board 1066 of touch pad assembly 1056 can be aligned with opening 1062 and cosmetic disc 1068 and button cap 1070 can be mounted onto the top side of circuit board 1066 for example. As shown in the embodiment illustrated in FIG. 14B, cosmetic disc 1068 can have a shape that may generally coincide with opening 1062. The input device can be held within the channel via a retaining mechanism such as screws, snaps, adhesives, press fit mechanisms, crush ribs and the like for example.

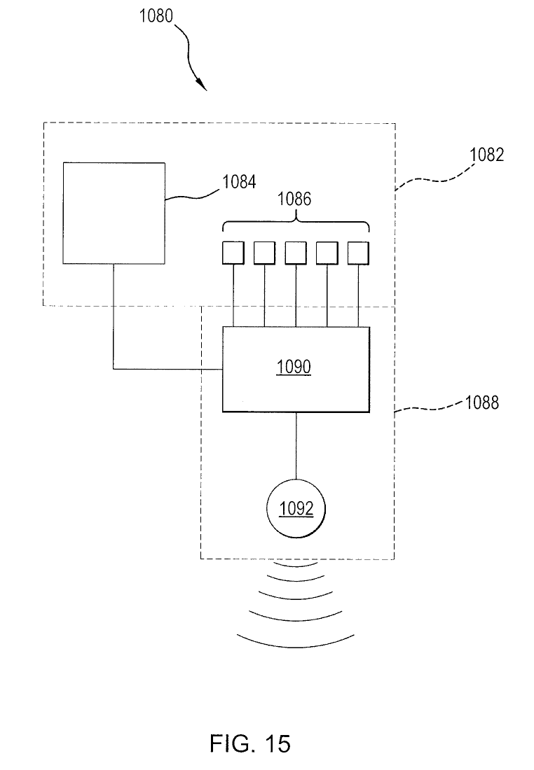

FIG. 15 illustrates a simplified block diagram of a remote control incorporating an input device according to some embodiments of the present disclosure. By way of example, input device 1082 may generally correspond to any of the previously described input devices. In this particular embodiment, input device 1082 may correspond to the input device shown in FIGS. 10A-10C, thus the input device may include touch pad 1084 and plurality of switches 1086. Touch pad 1084 and switches 1086 can be operatively coupled to wireless transmitter 1088. Wireless transmitter 1088 can be configured to transmit information over a wireless communication link so that an electronic device that has receiving capabilities can receive the information over the wireless communication link. Wireless transmitter 1088 may be widely varied. For example, it can be based on wireless technologies such as FM, RF, Bluetooth, 802.11 UWB (ultra wide band), IR, magnetic link (induction) and the like for example. In the embodiment illustrated in FIG. 15, wireless transmitter 1088 can be based on IR. IR generally refers to wireless technologies that convey data through infrared radiation. As such, wireless transmitter 1088 may generally include IR controller 1090. IR controller 1090 can take the information reported from touch pad 1084 and switches 1086 and convert this information into infrared radiation, as for example using light emitting diode 1092.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate processors or controllers may be performed by the same processors or controllers. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in a plurality of units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

What is claimed is:

1. An input device comprising:
multiple sensor elements comprising a first sensor element and a second sensor element, and
a controller configured to detect an input by performing a sensing operation associated with each of the multiple sensor elements, the sensing operation associated with the first sensor element being performed with a first sensitivity and the sensing operation associated with the second sensor element being performed with a second sensitivity.

2. The input device of claim 1 comprising a cover overlaying the multiple sensor elements, the cover comprising a first thickness at a location associated with the first sensor element and a second thickness at a location associated with the second sensor element.

3. The input device of claim 1, wherein the multiple sensor elements are circumferentially arranged relative to a first point.

4. The input device of claim 1, wherein the sensing operation comprises generating a value associated with a capacitance of the sensor element for which the sensing operation is being performed, and comparing the generated value with a threshold value to determine whether an input has been applied to the input device.

5. The input device of claim 4, wherein the threshold value establishes the sensitivity with which the sensing operation is performed.

6. The input device of claim 4, wherein the sensing operation associated with the first sensor element compares the generated value with a first threshold value to determine whether an input has been applied to the input device, and the sensing operation associated with the second sensor element compares the generated value with a second threshold value to determine whether an input has been applied to the input device.

7. The input device of claim 6, wherein the first threshold value is associated with the first sensor element in a lookup table and the second threshold value is associated with the second sensor element in the lookup table.

8. A method comprising:
providing multiple sensor elements,
performing a calibration operation for each of the multiple sensor elements to establish a baseline sense level, and
determining a threshold sense level for each of the multiple sensor elements based on the baseline sense level.

9. The method of claim 8, comprising circumferentially arranging the multiple sensor elements relative to a first point associated with an input device.

10. The method of claim 9, comprising determining whether an input has been applied to an input device by performing a sensing operation for each of the multiple sensor elements.

11. The method of claim 8, comprising covering the multiple sensor elements with an overlay, the overlay comprising a first thickness at a location associated with a first sensor element and a second thickness at a location associated with a second sensor element.

12. The method of claim 8, comprising storing the threshold sense level for each of the multiple sensor elements in a lookup table.

13. An electronic device comprising:
an input device comprising multiple sensor elements,
a surface covering the multiple sensor elements, the surface comprising a curvature, and
a controller configured to adjust a sensitivity of a sensing operation for each of the multiple sensor elements to compensate for the curvature of the surface.

14. The electronic device of claim 13, wherein the multiple sensor elements are circumferentially arranged relative to a first point.

15. The electronic device of claim 14, wherein the sensing operation is performed to determine whether an input has been applied to the input device.

16. The electronic device of claim 13, wherein the sensitivity of the sensing operation is based upon a threshold sense level associated with each of the multiple sensor elements in a lookup table.

17. An electronic device comprising:
an input device comprising multiple sensor elements, and
an overlay covering the multiple sensor elements,
the overlay comprising a varying thickness, and
the input device comprising a hardware configuration arranged to normalize capacitive sensing associated with the multiple sensor elements through the varying thickness of the overlay.

18. The electronic device of claim 17, wherein the hardware configuration comprises the multiple sensor elements comprising different areas.

19. The electronic device of claim 17, wherein the hardware configuration comprises a ground plane associated with the multiple sensor elements and comprising a varying density.

20. The electronic device of claim 17, wherein the hardware configuration comprises the overlay comprising multiple sections, the multiple sections comprising varying dielectric constants.

21. The electronic device of claim 17, wherein the hardware configuration comprises the multiple sensor elements and a ground plane, the multiple sensor elements and the ground plane arranged at varying distances from each other.
